(19) United States
(12) Patent Application Publication
(10) Pub. No.: US 2002/0000149 A1
(43) Pub. Date: Jan. 3, 2002

(54) Paper punching device

(76) Inventors: Manabu Miura, Osaka (JP); Nobuhiro Nishioka, Osaka (JP)

Correspondence Address: SMITH,GAMBRELL & RUSSELL, LLP, 1850 M Street, N.W. (Suite 800), Washington, DC, 20036, US

(21) Appl. No.: 09/864,375

(22) Filed: May 25, 2001

(30) Foreign Application Priority Data
May 31, 2000 (JP) 2000 - 166430

(51) Int. Cl. B26D 5/16

(52) U.S. Cl. 83/628; 83/627; 83/687

(57) ABSTRACT

A paper punching device is disposed on a paper conveyer passage for punching plural holes in a paper that passes on said paper conveyer passage, and comprises plural punches disposed on the upper side of said paper conveyer passage at right angles with the direction in which the paper is conveyed, plural pushing members mounted on the upper ends of said plural punches, and a punch-operating mechanism for operating said plural pushing mechanisms. The punch-operating mechanism comprises a cam shaft disposed along a direction in which said plural pushing mechanisms are arranged, plural cams mounted on said cam shaft, a cam drive mechanism for rotatively driving said cam shaft, and a cam position change-over mechanism which operates said cam shaft in the axial direction so as to be selectively brought to a first position where some cams out of the plural cams correspond to some pushing members out of said plural pushing members and to a second position where the other cams out of said plural cams correspond to the other pushing members out of said plural pushing members.

### FIELD OF THE INVENTION

The present invention relates to a paper punching device for punching the papers after the images have been formed thereon, in an image-forming machine such as a copier or a printer, on which the paper punching device is mounted.

### DESCRIPTION OF THE PRIOR ART

In recent years, there are widely put into practical use image-forming machines such as copiers and printers have been provided with a paper punching device for punching the papers after the images have been formed thereon, so that the papers can be filed. As the paper punching devices, there have been known those of the type in which the papers on which the image has been formed are once conveyed onto a paper-receiving plate for every manuscript and are punched at one time on the paper-receiving plate, and those of the so-called piece-by-piece punching type in which punches are arranged in the punching portion along the conveyer passage for conveying a paper on which the image has been formed, the paper is once stopped when it passes through the punching portion and then, is punched while it is at rest. Of the above two punching systems, the so-called piece-by-piece punching system is capable of effecting the punching in synchronism with the image-forming operation and hence, offers an advantage of effecting the punching at nearly the same time as that of operation for forming the image. Image-forming machines equipped with the punching device of the so-called piece-by-piece punching type have been disclosed in Japanese Utility Model Publication (Kokoku) No. 25919/1991 and Japanese Laid-open Patent Publication (Kokai) No. 190696/1991.

The paper punching device disclosed in the above Japanese Examined Utility Model Publication (Kokoku) No. 25919/1991 is constituted by a stopper which is arranged in the conveyer passage for conveying the paper on which the image has been formed to once stop the paper with its leading edge uniformly positioned, two punches disposed, on the upstream of the stopper, at right angles with a direction in which the paper is conveyed, and a cam operation mechanism for reciprocatingly moving the punches up and down. The punching device disclosed in the above Japanese Laid-open Patent Publication (Kokai) No. 190696/1991 is constituted by two punches disposed in a punching portion of the conveyer passage for conveying the paper on which the image has been formed, at right angles with the direction in which the paper is conveyed, a cam operation mechanism for reciprocatingly moving the punches up and down, and a paper-stop means for once stopping the paper in a state where the to-be-punched portion on the side of the trailing edge of the paper being conveyed is made correspondence to the above punching portion.

The paper punching devices disclosed in the above two publications are of the constitution which is capable of punching the holes in a number of only one kind. When it is desired to punch the holes of different kinds, it becomes necessary to replace the punches and the cam operation mechanism.

In order to solve the above-mentioned problem, Japanese Laid-open Patent Publication (Kokai) No. 26328/1999 discloses a paper punching device in which two kinds of holes have been set for effecting the punching, and the holes of either kind are selected to effect the punching. The paper punching device disclosed in the above publication comprises plural punches disposed in the paper conveyer passage at right angles with the direction of conveying the papers, plural pushing mechanisms for operating the plural punches, pushing mechanism-positioning means for operating said plural pushing mechanisms in a direction in which they are arranged to bring them to a first position and a second position, a cam shaft disposed along the direction in which the plural pushing mechanisms are arranged, and plural cams formed on the cam shaft to actuate the pushing mechanisms. The pushing mechanism-positioning means includes a changeover shaft mounting the plural pushing mechanisms, and a change-over shaft-operating mechanism for operating the change-over shaft in the axial direction to bring the plural pushing mechanisms to the first position and to the second position. When the change-over shaft is actuated by the pushing mechanism-positioning means to bring the plural pushing mechanisms to the first position, some pushing mechanisms correspond to some cams out of the plural cams. When the plural pushing mechanisms are brought to the second position, the other pushing mechanisms correspond to the other cams.

However, the paper punching device disclosed in the above Japanese Laid-open Patent Publication (Kokai) No. 26328/1999 contains very many constituent parts and the device as a whole becomes bulky since it is provided with the pushing mechanism-positioning means having a change-over shaft that is disposed in parallel with the cam shaft and mounts the plural pushing mechanisms. Besides, in the paper punching device disclosed in the above publication, the pushing mechanism tends to become bulky since the plural pushing mechanisms mounted on the change-over shaft are moved in the axial direction so as to selectively correspond to the plural punches. In the paper punching device disclosed in the above publication as descried above, the mechanisms themselves become of a large-size since they are constituted by many parts, resulting in an increase in the number of parts and in the size of the mechanisms and producing large noise due to the operation of the individual parts, which are problems.

### SUMMARY OF THE INVENTION

It is an object of the present invention to provide a paper punching device in which a change-over mechanism for selectively operating the necessary punches out of plural punches can be constituted in a compact size by using a decreased number of parts.

In order to accomplish the above-mentioned object according to the present invention, there is provided a paper punching device disposed on a paper conveyer passage for punching plural holes in a paper that passes on said paper conveyer passage, comprising:

plural punches disposed on the upper side of said paper conveyer passage at right angles with the direction in which the paper is conveyed;

plural pushing members mounted on the upper ends of said plural punches; and

a punch-operating mechanism for operating said plural pushing mechanisms;

wherein said punch-operating mechanism includes a cam shaft disposed along a direction in which said plural pushing mechanisms are arranged, plural cams mounted on said cam shaft, a cam drive mechanism for rotatively driving said cam shaft, and a cam position change-over mechanism which operates said cam shaft in the axial direction so as to be selectively brought to a first position where some cams out of the plural cams correspond to some pushing members out of said plural pushing members and to a second position where the other cams out of said plural cams correspond to the other pushing members out of said plural pushing members.

It is desired that each pushing member is provided with a return member having a pair of support portions mounted on both ends thereof and extending upward and a return operation portion coupling the upper ends of said pair of support portions together, and that the cam acts on the lower surface of said return member.

It is further desired that the return operation portion of said return member is provided with sub-return operation portions corresponding to said cam in a state where said cam has not been brought to the position corresponding to the pushing member.

### BRIEF DESCRIPTION OF THE DRAWINGS

FIG. 1 is a view schematically illustrating an embodiment of an image-forming machine equipped with an after-treatment device having a paper punching device constituted according to the present invention;

FIG. 2 is a plan view illustrating, partly in a cutaway manner, a three-hole-punching state of the paper punching device constituted according to the present invention;

FIG. 3 is a plan view illustrating, partly in a cutaway manner, a two-hole-punching state of the paper punching device constituted according to the present invention;

FIG. 4 is a sectional view along the line A-A in FIG. 2;

FIG. 5 is a front view of a pushing mechanism constituting the paper punching device according to the present invention;

FIG. 6 is a perspective view of a rotation control member constituting a spring clutch used for the paper punching device constituted according to the present invention;

FIG. 7 is a side view of a flapper-type solenoid used for the paper punching device constituted according to the present invention;

FIG. 8 is a plan view illustrating a relationship between the flapper-type solenoid and the rotation control member constituting the spring clutch, that are used for the paper punching device according to the present invention;

FIG. 9 is a view illustrating operations of the flapper-type solenoid and of the rotation control member constituting the spring clutch, that are used for the paper punching device according to the present invention;

FIG. 10 is a view illustrating operations of a punching unit and of an operation cam of the punching unit, that are used for the paper punching device according to the present invention;

FIG. 11 is a block diagram illustrating the constitution of a control means for controlling the paper punching device according to the present invention; and

FIG. 12 is a flow chart illustrating the processing procedure of the control means shown in FIG. 11.

### DETAILED DESCRIPTION OF THE PREFERRED EMBODIMENTS

The invention will be described in further detail with reference to the accompanying drawings which illustrate preferred embodiments of the paper punching device constituted according to the present invention.

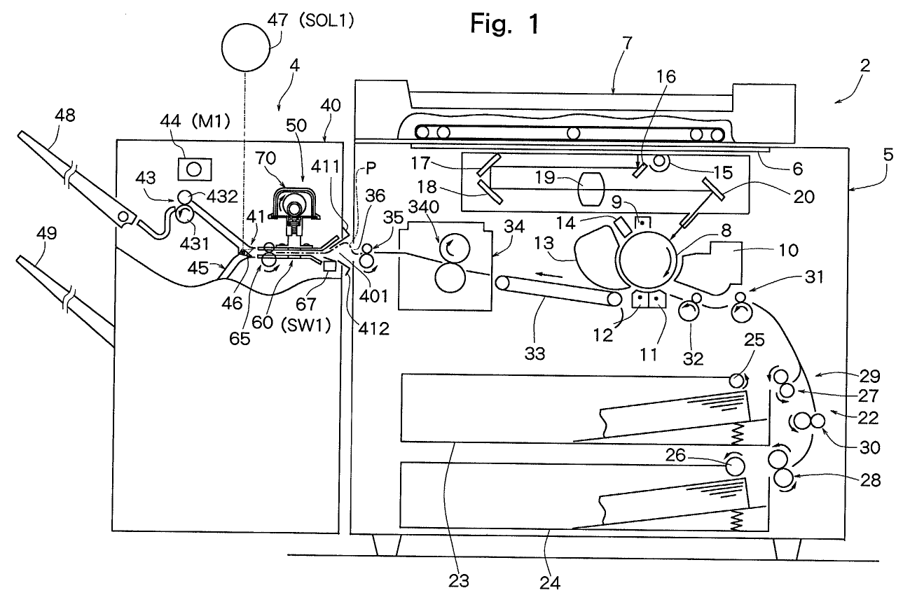

FIG. 1 illustrates an electrostatic copier 2 which is an image-forming machine, and an after-treatment device 4 equipped with a paper punching device disposed being coupled to the electrostatic copier 2 and constituted according to the present invention.

The electrostatic copier 2 that is shown is provided with a machine housing 5 of a rectangular parallelepiped shape. On the upper surface of the machine housing 5 is disposed a stationary transparent plate 6 on which will be placed a manuscript that is to be copied. An automatic manuscript conveyer device 7 is disposed on the upper side of the stationary transparent plate 6. The automatic manuscript conveyer device 7 includes a manuscript-placing portion on which the manuscript to be copied is placed and a manuscript conveyer portion having a manuscript conveyer belt mechanism for conveying the manuscript placed on the manuscript-placing portion to a predetermined position of the stationary transparent plate 6.

As shown in FIG. 1, a photosensitive material drum 8 is rotatably disposed nearly in the central portion in the machine housing 5. The photosensitive material drum 8 is rotatively driven in a direction indicated by an arrow by a drive means that is not shown. The photosensitive material drum 8 is surrounded, as viewed in the direction of rotation indicated by the arrow, by a corona discharger 9 for electric charging, a developer 10, a corona discharger 11 for transfer, a corona discharger 12 for peeling-off, a cleaning unit 13 and a charge-removing lamp 14 in this order. The illustrated electrostatic copier includes an optical system constituted by an irradiation lamp 15 disposed above the photosensitive material drum 8, a first mirror 16, a second mirror 17, a third mirror 18, a lens 19 and a fourth mirror 20. This optical system is so constituted that the manuscript placed on the stationary transparent plate 6 is irradiated with light from the irradiation lamp 15, and the reflected optical image is focused on the outer peripheral surface of the photosensitive material drum 8 through the first mirror 16, second mirror 17, third mirror 18, lens 19 and fourth mirror 20.

The illustrated electrostatic copier 2 includes a paper feeder 22 for feeding the paper onto the transfer zone between the corona discharger 11 for transfer and the photosensitive material drum 8.

The paper feeder 22 includes paper cassettes 23 and 24 for holding the papers on which images are to be transferred, paper delivery rollers 25 and 26, pairs of handling rollers 27 and 28, a guide passage 29, pairs of conveyer rollers 30 and 31, and a pair of resist rollers 32. The pairs of rollers of the thus constituted transfer paper feeder 22 are rotatively driven in the directions indicated by arrows by a drive means that are not shown.

On the transfer paper delivery side of the transfer zone, there are disposed a transfer paper conveyer belt mechanism 33, a fixing device 34 having a pair of fixing rollers 340, and a pair of discharge rollers 35. The conveyer belt mechanism and the rollers are driven in the directions indicated by arrows by a drive means that are not shown.

While the photosensitive material drum 8 is rotatively driven in the direction indicated by the arrow in the thus constituted electrostatic copier 2, the corona discharger 9 electrically charges the photosensitive material on the photosensitive material drum 8 substantially uniformly into a particular polarity, the manuscript placed on the stationary transparent plate 6 is irradiated with light from the irradiation lamp 15, and the reflected optical image is projected onto the photosensitive material drum 8 via the first mirror 16, second mirror 17, third mirror 18, lens 19 and fourth mirror 20, so that an electrostatic latent image is formed on the photosensitive material drum 6. Thereafter, the electrostatic latent image on the photosensitive material drum 8 is developed into a toner image by the developer 10. On the other hand, the paper held in the paper cassette 23 or 24 of the paper feeder 22 is delivered onto the guide passage 29 by the delivery roller 25 or 26 through the pair of handling rollers 27 or 28, is once stopped by the pair of resist rollers 32, and is conveyed onto the transfer zone in synchronism with the toner image formed on the photosensitive material drum 8. The toner image is transferred onto the paper conveyed onto the transfer zone as the paper passes through between the photosensitive material drum 8 on which the toner image is formed and the corona discharger 11 for transfer. The paper onto which the toner image is transferred is peeled off the photosensitive material drum 8 by the action of the corona discharger 12 for peeling-off, is conveyed by the transfer paper conveyer belt mechanism 33 to the fixing device 34 where the image is fixed by heating, and is discharged by the pair of discharge rollers 35 through a discharge port 36. After the transfer step has been completed as described above, the toner adhered to the outer peripheral surface of the photosensitive material drum 8 is removed by the cleaning unit 13. Further, the surface of the photosensitive material is irradiated with charge-removing light from the charge-removing lamp 14, so that the electric charge is removed therefrom.

The after-treatment device 4 will be described next.

The after-treatment device 4 in the illustrated embodiment has a device housing 40. The device housing 40 has a paper introduction port 401 at a position opposed to the discharge port 36 at an end of the copier body 2, and has, arranged therein, a first paper conveyer passage 41 extending from the paper introduction port 401. An introduction portion on the side of the paper introduction port 401 in the first paper conveyer passage 41 is constituted by a pair of guide plates 411 and 412 that are opened up and down on the side of the discharge port 36. A pair of discharge rollers 43 constituted by a drive roller 431 and a driven roller 432 are disposed at an end on the discharge side of the first paper conveyer passage 41. The drive roller 431 constituting the pair of discharge rollers 43 is transmission-coupled to an electric motor 44 (M1) as a drive source via a drive mechanism that is not shown, and is rotatively driven in a direction indicated by an arrow. A second paper conveyer passage 45 is branched from an intermediate portion of the first paper conveyer passage 41, and extends to, for example, a staple-treatment portion (not shown) which is an after-treatment device.

A branching pawl 46 is disposed at a branching portion between the first paper conveyer passage 41 and the second paper conveyer passage 45. The branching pawl 46 is operated to a first position indicated by a solid line in FIG. 1 and to a second position indicated by a broken line in FIG. 1 by an electromagnetic solenoid 47 (SOLL). When the electromagnetic solenoid 47 (SOLL) is de-energized, the branching pawl 46 is brought to the first position indicated by the solid line in FIG. 1, whereby the paper introduced through the paper introduction port 401 is conveyed toward the pair of discharge rollers 43 passing through the first paper conveyer passage 41. When the electromagnetic solenoid 47 (SOLL) is energized, on the other hand, the branching pawl 46 is brought to the second position indicated by the broken line in FIG. 1, whereby the paper introduced through the paper introduction port 401 is conveyed toward the second paper conveyer passage 45 from the branching portion of the first paper conveyer passage 41.

A paper punching device 50 is disposed between the pair of guide plates 411, 412 and the branching portion of the first paper conveyer passage 41 from where the second paper conveyer passage 45 is branched. The paper punching device 50 will be described later in detail. On the discharge side of the housing 40 (left side in FIG. 1), there are disposed a tray 48 for non-sorting at an upper portion and a tray 49 for sorting under the tray 48 for non-sorting so as to be allowed to be shifted up and down.

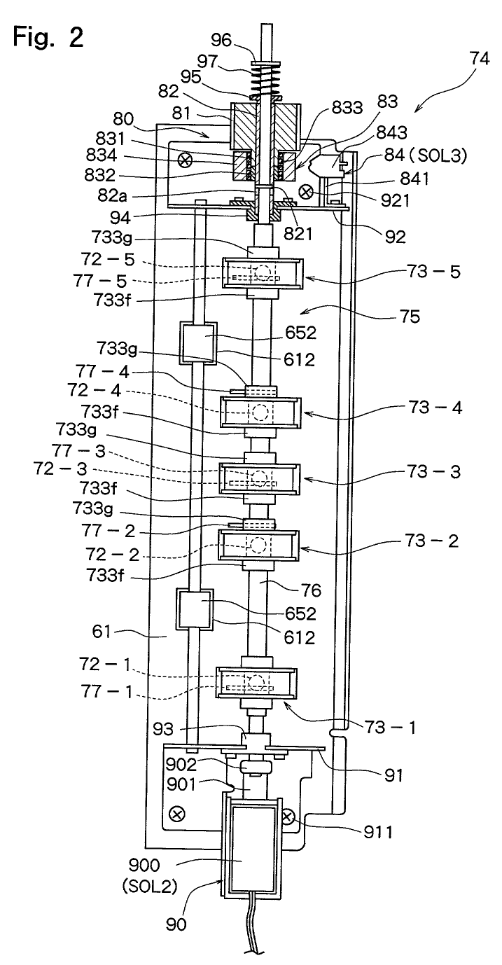

Next, the paper punching device 50 will be described in detail with reference also to FIGS. 2 to 7.

The paper punching device 50 includes a paper guide means 60 and a punching unit 70.

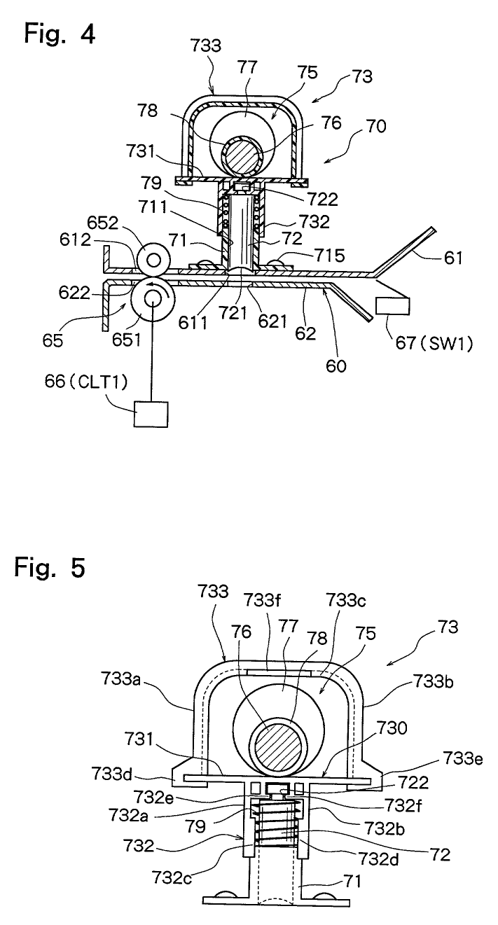

The paper guide means 60 is constituted by an upper guide plate 61 and a lower guide plate 62 as chiefly shown in FIG. 4. The end on the upstream side of the upper guide plate 61 (right end in FIG. 4) is tilted upward and is connected to the guide plate 411. Further, the end on the upstream side of the lower guide plate 62 (right end in FIG. 4) is tilted downward. In the upper guide plate 61 are formed plural through holes 611 (five holes in the illustrated embodiment) corresponding to the number of punches that will be described later at right angles with the direction in which the paper is conveyed (at right angles with the surface of the paper in FIG. 1) in a predetermined punching portion. In the lower guide plate 62 are formed plural punching holes 621 (five holes in the illustrated embodiment) at positions corresponding to the plural through holes 611 formed in the upper guide plate 61 in the predetermined punching portion. Therefore, the lower guide plate 62 having punching holes 621 works as a punching die.

A pair of resist rollers 65 constituted by a drive roller 651 and a driven roller 652 are disposed at the end on the downstream side of the paper guide means 60 constituted as described above. The drive roller 651 is disposed protruding upward through an opening 622 formed in the lower guide plate 62, and the driven roller 652 is disposed protruding downward through an opening 612 formed in the upper guide plate 61. The drive roller 651 constituting the pair of resist rollers 65 is transmission-coupled to the electric motor 44 (M1) through an electromagnetic clutch 66 (CLT1) and is rotatively driven in a direction indicated by an arrow. When the electromagnetic clutch 66 (CLT1) is de-energized, the drive roller 651 and the electric motor 44 (M1) are not transmission-coupled. When the electromagnetic clutch 66 (CLT1) is energized, the drive roller 651 and the electric motor 44 (M1) are transmission-coupled. In the illustrated embodiment, a paper detector 67 (SW1) is disposed between the paper guide means 60 and the pair of guide plates 411, 412. The paper detector 67 (SW1) detects the paper introduced into the after-treatment device 4 from the copier body 2 through the paper introduction port 401, and sends a detection signal to a control means that will be described later.

The punching unit 70 includes plural punch guides 71 (five punch guides in the illustrated embodiment), plural punches (five punches in the illustrated embodiment) 72 (72-1, 72-2, 72-3, 72-4, 72-5) disposed in the plural punch guides 71 so as to slide up and down, pushing mechanisms 73 (73-1, 73-2, 73-3, 73-4, 73-5) fitted to the upper ends of the plural punches 72, and a punch-operating mechanism 74 for selectively operating each of the plural pushing mechanisms 73.

The plural punch guides 71 are constituted by cylindrical members having through holes 711 corresponding to the outer diameter of the punches 72 and having outer peripheral surfaces formed in a square shape in cross section, disposed on the upper guide plate 61 at positions corresponding to the plural through holes 611, and have mounting flanges 712 attached to the lower ends thereof and secured to the upper guide plate 61 by plural screws 715. The thus constituted plural punch guides 71 are disposed in a direction at right angles with the direction in which the paper is conveyed along the first paper conveyer passage 41 (in a direction perpendicular to the surface of the paper in FIGS. 1 and 4).

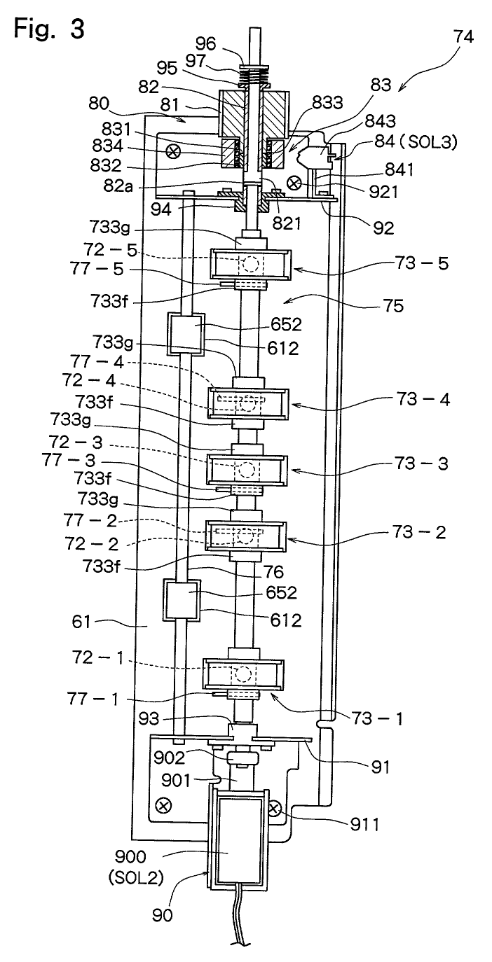

Each punch 72 has a punching blade 721 at the lower end thereof and an annular engaging groove 722 in the outer peripheral surface at the upper end thereof. The thus constituted punches 72 are fitted in the through holes 711 formed in the plural punch guides 71 so as to slide up and down. Among the punches 72-1, 72-2, 72-3, 72-4 and 72-5 as shown in FIGS. 2 and 3, the punches 72-1, 72-3 and 72-5 are disposed in the three-hole-punching portion, and the punches 72-2 and 72-4 are disposed in the two-hole-punching portion.

Next, the pushing mechanisms 73 will be described with reference chiefly to FIGS. 4 and 5.

The pushing mechanism 73 in the illustrated embodiment includes a pushing member 730 having a horizontal pushing portion 731 and a cylindrical support portion 732 hanging down from the central portion of the pushing portion 731, and a return member 733 mounted on both ends of the pushing portion 731 and is formed like an arch facing upward. The pushing portion 731 constituting the pushing member 730 is formed in a rectangular shape, and a cam 77 that will be described later acts on the upper surface thereof.

The cylindrical support portion 732 constituting the pushing member 730 has side portions 732a, 732b corresponding to both side surfaces of the punch guide 71 of a rectangular shape in cross section, and a back side portion (not shown) corresponding to the back side surface of the punch guide 71, and is opened on the side corresponding to the front side surface of the punch guide 71. Guide portions 732c and 732d are provided at the lower front ends of the side portions 732a and 732b and protrude inward. The gap between the guide portions 732c and 732d is slightly larger than the diameter of the punch 72, so that the punch 72 is inserted into between the guide portions 732c and 732d in a manner as will be described later. The support member 732 having the side portions 732a, 732b, the back side portion (not shown) and the guide portions 732c, 732d, permit the punch guide 71 to be fitted therein to slide up and down, thereby to support the pushing member 73.

On the upper inner surfaces of the side portions 732a and 732b constituting the support portion 732, there are provided engaging portions 732e and 732f protruding inward. The gap between the engaging portions 732e and 732f is set to correspond to the annular engaging groove 722 formed in the upper outer peripheral surface of the punch 72. By inserting the punch 72 in the support member 732 from the front side of the support member 732 passing between the guide portions 732c and 732d and by bringing the annular engaging groove 722 formed in the upper outer peripheral surface of the punch 72 into engagement with the engaging portions 732e and 732f, therefore, the pushing member 730 is mounted on the punch 72. The thus constituted pushing member 730 is molded as a unitary structure by using a suitable synthetic resin.

A compression coil spring 79 is disposed between the upper end of the punch guide 71 and the engaging portions 732e, 732f of the support portion 732 of the pushing member 730. Due to the resilient force of the compression coil spring 79, the pushing member 730 is urged upward at all times.

The return member 733 constituting the pushing mechanism 73 has support portions 733a, 733b extending up and down, and a return operation portion 733c coupling the upper ends of the support members 733a and 733b together, which are formed as a unitary structure using a suitable synthetic resin. Engaging portions 733d and 733e having an engaging groove are provided at the lower ends of the support portions 733a and 733b. By bringing the engaging grooves of the engaging portions 733d and 733e into engagement with both ends of the pushing portion 731, the return member 733 is mounted on the pushing member 730. The return operation portion 733c has a lower surface on which the cam 77 that will be described later acts. That is, after the punching operation, the punch 72 moves upward to a predetermined retracted position with the turning of the cam 77 due to the resilient force of the compression coil spring 79. Here, when the resisting force between the punch 72 and the punched paper is larger than the resilient force of the compression coil spring 79, it becomes difficult to operate the punch toward the retracted position. In the illustrated embodiment, however, when the resisting force makes it difficult to operate the punch 72 toward the retracted position, the cam 77 that turns acts on the lower surface of the return operation portion 733c of the return member 733 to push the return member 733 up, making it possible to bring the punch 72 coupled to the pushing member 730 mounting the return member 733 to the predetermined retracted position.

In the illustrated embodiment, sub-return operation portions 733f and 733g are provided on both sides of the central portion of the return operation portion 733c constituting the return member 733, the sub-return operation portions 733f and 733g protruding in the axial direction of the cam shaft 81 mounting the cam 77 that will be described later (see FIGS. 2 and 3). The sub-return operation portions 733f and 733g have their lower flat surfaces in flush with the lower surface of the return operation portion 733c, and will be opposed to the cam 77 when the cam 77 is brought to the non-acting position being displaced in the axial direction from the acting position where the cam 77 is opposed to the pushing portion 731 and to the return member 733 as will be described later. When the cam 77 is brought to the non-actin position, therefore, the punch 72 does not act. In case the punch 72 has moved down due to some cause, however, the cam 77 acts on the lower surface of either the sub-return operation portion 733f or 733g to bring the punch 72 to the predetermined return position. Though the illustrated embodiment has dealt with the case where the sub-return operation portions 733f and 733g were provided on both sides of the central portion of the return operation portion 733c constituting the return member 733, it should be noted that this is to form the return members 733 in common, and the sub-return operation portion may be provided on either side corresponding to the cam 77 in a state where the cam 77 is brought to a position not corresponding to the pushing portion 731.

Next, the punch-operating mechanism 74 will be described with reference to FIGS. 2 to 8. The punch-operating mechanism 74 includes a cam mechanism 75, a cam drive mechanism 80 for selectively rotatively driving the cam mechanism 75, and a cam position change-over mechanism 90 for changing the cam mechanism 75 over to a first position (three-hole-punching position in the illustrated embodiment) and to a second position (two-hole-punching position in the illustrated embodiment).

The cam mechanism 75 in the illustrated embodiment includes a cam shaft 76 disposed along the direction in which the pushing member 730 is arranged to constitute the plural pushing mechanisms 73, plural cams (five cams in the illustrated embodiment) 77 (77-1, 77-2, 77-3, 77-4, 77-5) mounted on the predetermined positions of the cam shaft 76, and plural guide cylinder sleeves (five guide cylinder sleeves in the illustrated embodiment) 78 (78-1, 78-2, 78-3, 78-4, 78-5) mounted on the cam shaft 76 neighboring the cams 77 (77-1, 77-2, 77-3, 77-4, 77-5).

The cam shaft 76 is disposed through space defined by the pushing portions 731 of the pushing members 730 constituting the plural pushing mechanisms 73 and by the return members 733, and is rotatably supported at its both ends by a front side plate 91 and a back side plate 92 mounted on the upper guide plate 61 with screws 911 and 921 via bearings 93 and 94.

The cams 77 (77-1, 77-2, 77-3, 77-4, 77-5) are formed of a suitable synthetic resin and have outer peripheral surfaces that work as cam surfaces. The guide cylinder sleeves 78 (78-1, 78-2, 78-3, 78-4, 78-5) are formed of a suitable synthetic resin and have a radius of the outer peripheral surfaces thereof corresponding to the shortest radius of the cams 77. When the cams 77 are not opposed to the pushing portions 731 of the pushing members 730, therefore, the guide sleeves 78 are brought to a position to correspond to the pushing portions 731. Due to the thus constituted guide sleeves 78, the cam shaft 76 can be smoothly operated in the axial direction by the cam position change-over mechanism 90 which will be described later. The cam 77 and the guide sleeve 78 may be molded as a unitary structure.

Next, described below is the cam operation mechanism 80.

The cam drive mechanism 80 in the illustrated embodiment includes a drive gear 81 disposed at an end on the back side of the cam shaft 77 (upper side in FIGS. 2 and 3), and a spring clutch 83 for transmitting, or disconnecting, the driving force of the drive gear 81 to, or from, the cam shaft 77. The drive gear 81 is allowed to move relative to the cam shaft 77 in the axial direction, and is rotatably mounted on a drive sleeve 82 that is so fitted as to rotate together with the cam shaft 77. The drive gear 81 is transmission-coupled to the electric motor 44 (M1) through a drive mechanism that is not shown. In the drive sleeve 82 is formed an elongated hole 82a elongating in the axial direction, and a pin 821 secured to the cam shaft 77 is fitted to the elongated hole 82a. In FIGS. 2 and 3, the left end of the drive sleeve 82 is rotatably supported by the bearing 94. Therefore, the cam shaft 77 is allowed to slide in the axial direction in a range of the elongated hole 82a formed in the drive sleeve 82. On the back side of the drive sleeve 82 of the cam shaft 77 (upper side in FIGS. 2 and 3), there is slidably mounted a spring shoe 95 to come in contact with an end surface on the back side of the drive sleeve 82, and there is secured another spring shoe 96 on a further back side. A compression coil spring 97 is disposed between the spring shoe 95 and the spring shoe 96. Due to the resilient force of the compression coil spring 97, therefore, the end surface on the front side of the drive sleeve 82 comes in contact with the bearing 94, and the cam shaft 77 is urged toward the back side (upper side in FIGS. 2 and 3).

Next, the spring clutch 83 will be described.

The spring clutch 83 in the illustrated embodiment includes a first boss member 831 formed integrally with the drive gear 81, a second boss member 832 that is disposed being opposed to the first boss member 831 and is constituted to rotate together with the drive sleeve 82, a coil spring 833 fitted upon covering the first boss member 831 and the second boss member 832, and a rotation control member 834 disposed upon covering the coil spring 833.

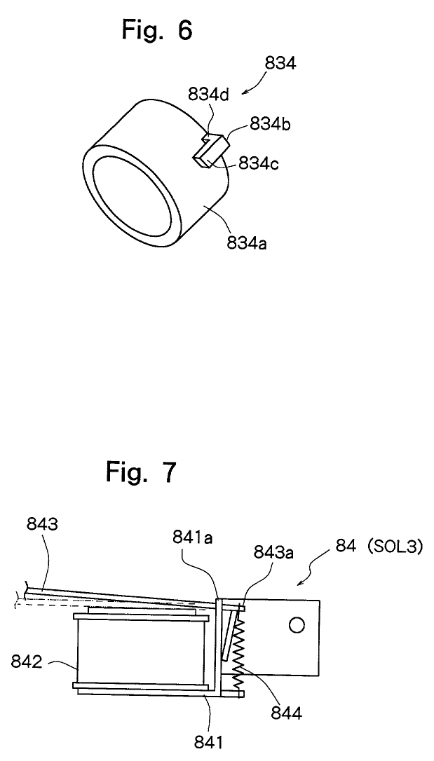

The coil spring 833 is engaged, at its one end, with a groove formed in the second boss member 832 and is engaged, at its other end, with a groove formed in the rotation control member 834. The rotation control member 834 includes a main body 834a which is a hollow sleeve member and an anchoring pawl 834b formed on the outer periphery of the main body 834a, as shown in FIG. 6. The anchoring pawl 834b includes an anchoring portion 834c disposed at a predetermined gap from the outer peripheral surface and a support portion 834d for coupling an end on the back side of the anchoring portion 834c to the main body 834a.

In the thus constituted spring clutch 83, when the flapper of the flapper-type solenoid 84 (SOL3) that will be described later comes into engagement with the anchoring pawl 834b to limit the rotation of the rotation control member 834, the coil spring 833 expands due to the rotation of the first boss member 831 formed integrally with the drive gear 78. Accordingly, the drive gear 78 and the first boss member 831 simply rotate on the cam shaft 81 without transmitting the driving force to the cam shaft 81. On the other hand, so far as the flapper of the flapper-type solenoid 84 (SOL3) that will be described later does not engage with the anchoring pawl 834b, the rotation control member 834 is allowed to rotate. Therefore, the coil spring 833 contracts and comes into intimate contact with the outer peripheral surfaces of the first boss member 831 and of the second boss member 832, so that the first boss member 831 and the second boss member 832 are connected together via the coil spring 833. Therefore, the driving force transmitted to the drive gear 8 is transmitted to the cam shaft 81 through the first boss member 831, coil spring 833, second boss member 832, driving sleeve 82 and pin 821.

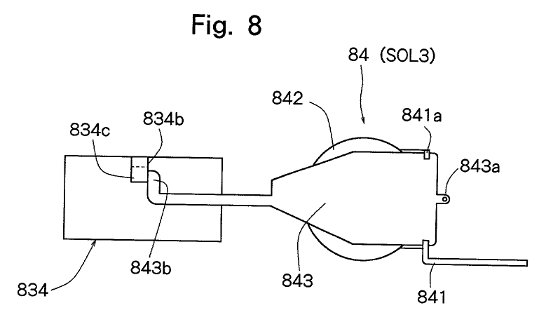

Next, the flapper-type solenoid 84 (SOL3) for controlling the spring clutch 83 will be described with reference also to FIGS. 7 and 8.

The flapper-type solenoid 84 (SOL3) includes a bracket 841 attached to the back side plate 92 by a fastening means such as screws, a solenoid 842 mounted on the bracket 841, a flapper 843 that is disposed on the upper side of the solenoid 842 and is supported, at its one end (right end portion in FIGS. 7 and 8), by the bracket 841 pivotably on a support portion 841a as a fulcrum, and a coil spring 844 stretched between a spring-mounting portion 843a formed at an end of the flapper 843 (right end in FIGS. 7 and 8) and the bracket 841.

The flapper 843 has, at the other end (left end portion in FIGS. 7 and 8) thereof, an engaging portion 843b for coming into engagement with the anchoring pawl 834b of the rotation control member 834, as shown in FIG. 8. The engaging portion 843b is formed protruding toward the anchoring pawl 834b so as to come into engagement with the anchoring portion 834c of the anchoring pawl 834b. In the thus constituted flapper-type solenoid 84 (SOL3), when the solenoid 842 is de-energized, the flapper 843 is urged by a coil spring 844 to swing in the clockwise direction on the support portion 841a as a fulcrum, as indicated by a solid line in FIG. 7. In this state, the engaging portion 843b of the flapper 843 is brought to a position to come into engagement with the anchoring portion 834c of the anchoring pawl 834b. When the solenoid 842 of the flapper-type solenoid 84 (SOL3) is energized, on the other hand, the flapper 843 is attracted by the attracting force of the solenoid 842 against the resilient force of the coil spring 844 as indicated by a two-dot chain line in FIG. 7.

Next, the cam position change-over mechanism 90 will be described with reference to FIGS. 2 and 3. The cam position change-over mechanism 90 in the illustrated embodiment includes an electromagnetic solenoid 900 (SOL2) disposed on the front side of the cam shaft 77 (on the lower side in FIGS. 2 and 3) and a coupling member 902 for coupling a plunger 901 of the electromagnetic solenoid 900 (SOL2) to the cam shaft 77.

In the thus constituted cam position change-over mechanism 90, when the electromagnetic solenoid 900 (SOL2) is de-energized, the plunger 901 protrudes as shown in FIG. 2, the cam shaft 76 is moved backward (upward in FIGS. 2 and 3) due to the resilient force of the compression coil spring 97 and is brought to the first position (three-hole-punching position) in FIG. 2. In a state where the cam shaft 76 is brought to the first position, the cams 77-1, 77-3 and 77-5 are brought to the positions so as to correspond to the pushing mechanisms 73-1, 73-3 and 73-5. When the electromagnetic solenoid 900 (SOL2) is energized, on the other hand, the plunger 901 is attracted overcoming the resilient force of the compression coil spring 97. Accordingly, the cam shaft 76 moves toward the front side (downward in FIGS. 2 and 3) and is brought to the second position (two-hole-punching position) shown in FIG. 3. In a state where the cam shaft 76 is brought to the second position, the cams 77-2 and 77-4 are brought to the positions so as to be corresponded to the pushing mechanisms 73-2 and 73-4.

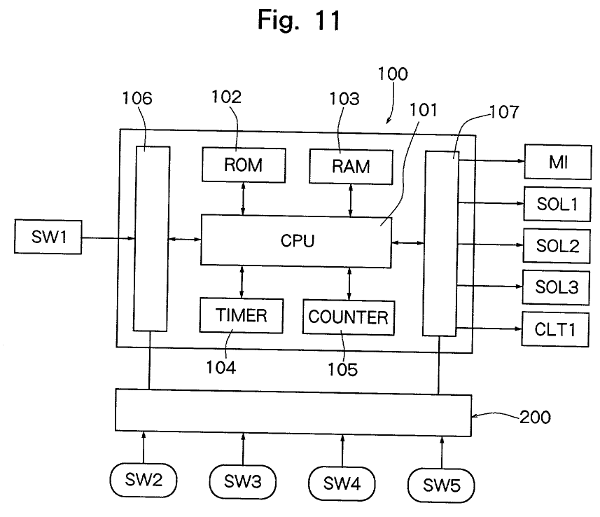

The after-treatment device 4 equipped with the illustrated paper punching device 50 further has a control means 100 shown in FIG. 11. The control means 100 is constituted by a microcomputer and includes a central processing unit (CPU) 101 for executing the processing according to a control program, a read-only memory (ROM) 102 for storing the control program, a random access memory (RAM) 103 for storing the results of processing, a timer 104 (T), a counter 105, an input interface 106, and an output interface 107. The input interface 106 of the thus constituted control means 100 receives a detection signal from the paper detector 67 (SW1) or the like, and sends, through an output interface 107 thereof, control signals to the electric motor 44 (M1), electromagnetic solenoid 47 (SOL1), electromagnetic solenoid 750 (SOL2), flapper-type solenoid 84 (SOL3) and electromagnetic clutch 66 (CLT1), etc. The control means 100 is connected to a control means 200 of the copier body 2, and control signals are exchanged between them. The control means 200 of the copier body 2 receives copy data from a copying start key 201 (SW2), a two-hole-punching key 202 (SW3), a three-hole-punching key 203 (SW4), a staple key 204 (SW5) arranged on the operation panel of the copier body 2 or the like.

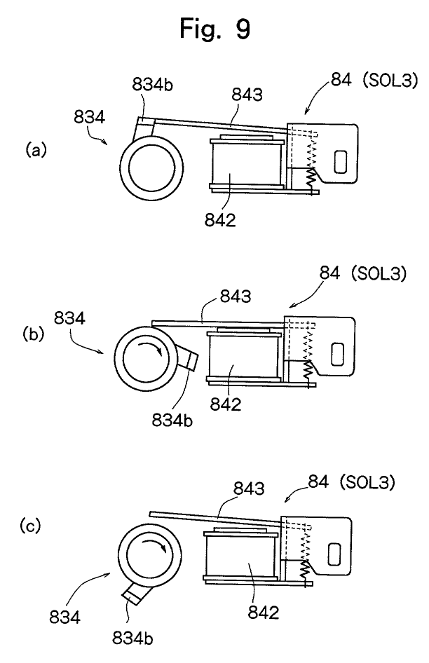

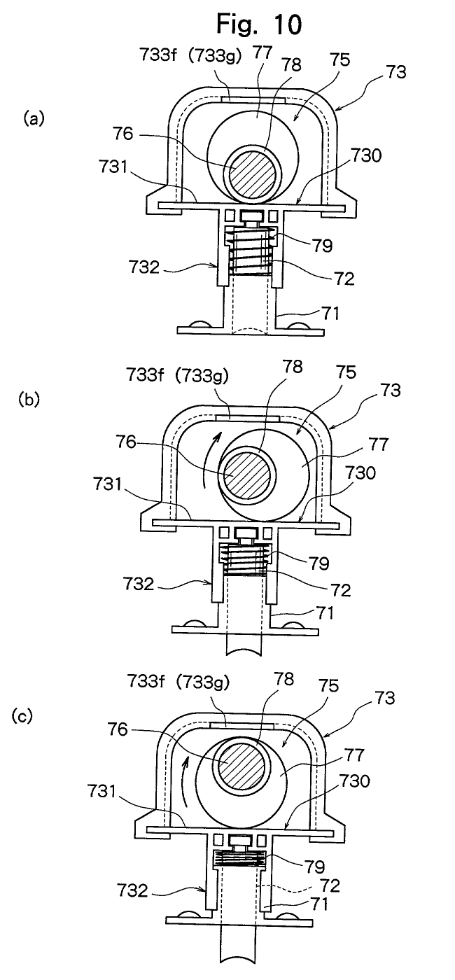

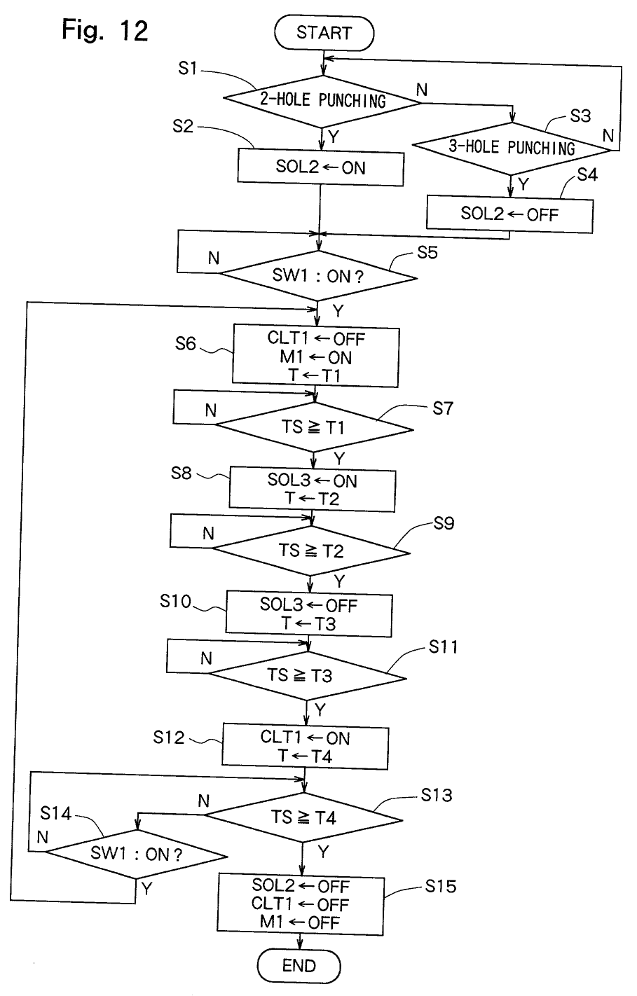

The after-treatment device equipped with the paper punching device of the illustrated embodiment is constituted as described above. The punching operation will now be described with reference to FIGS. 9 and 10 which illustrate the operation conditions, and FIG. 12 which is a flowchart.

When the control means 100 starts operating, the control means 200 of the copier body 2 first checks whether the two-hole-punching key 202 (SW3) is depressed to specify the two-hole punching (step S1). When the two-hole punching is specified, the routine proceeds to step S2. When the two-hole punching has not been specified, the routine proceeds to step S3. When the two-hole punching has been specified at step S1, the routine of the control means 100 proceeds to step S2 to energize the electromagnetic solenoid 900 (SOL2) that constitutes the cam position change-over mechanism 90 to operate the cam shaft 76. As the electromagnetic solenoid 900 (SOL2) is energized, the cam shaft 76 is brought to the second position (two-hole-punching position) shown in FIG. 3 as described above, and the cams 77-2 and 77-4 are brought to the positions corresponding to the pushing members 730 of the pushing mechanisms 73-2 and 73-4. When the two-hole punching has not been specified at step S1, on the other hand, the control means 100 proceeds to step S3 where the control means 200 of the copier body 2 checks whether the three-hole-punching key 203 (SW4) is depressed to specify the three-hole punching. When the three-hole punching has not been specified at step S3, the control means 100 judges that the punching has not been specified and returns back to the start. When the three-hole punching has been specified at step S3, the control means 100 proceeds to step S4 to de-energize the electromagnetic solenoid 900 (SOL2). When the electromagnetic solenoid 900 (SOL2) is de-energized, the cam shaft 76 is brought to the first position (three-hole-punching position) shown in FIG. 2 as described above, and the cams 77-1, 77-3 and 77-5 are brought to the positions corresponding to the pushing members 730 of the pushing mechanisms 73-1, 73-3 and 73-5.

When the pushing mechanism 73 is set to the two-hole-punching state or to the three-hole-punching state, both the flapper-type solenoid 84 (SOL3) and the rotation control member 834 are under a state as shown in FIG. 9(a). That is, the flapper-type solenoid 84 (SOL3) has been de-energized, and the flapper 843 is brought to a position where the anchoring portion 843b engages with the anchoring portion 834c of the anchoring pawl 834b. Further, the cam 77 mounted on the cam shaft 76 and the pushing mechanism 73 are under a state shown in FIG. 10(a). That is, the smallest diameter portion of the cam 77 is in contact with the upper surface of the pushing portion 731 of the pushing member 730 constituting the pushing mechanism 73. Therefore, the punch 72 operated by the pushing mechanism 73 is brought to the retracted position. Here, in this embodiment, it is presumed that the electromagnetic solenoid 47 (SOL1) has been de-energized, and the branching pawl 46 has been brought to the first position indicated by the solid line in FIG. 1.

When the pushing mechanisms 73 are set to the two-hole-punching state or to the three-hole-punching state as described above, the control means 100 proceeds to step S5 and checks whether the paper detector 67 (SW1) has been turned on. That is, the control means 100 checks whether the leading edge of the paper having image formed thereon in the copier body 2 and introduced into the after-treatment device 4 passing through the paper introduction port 401, has reached the paper detector 67 (SW1). When the paper detector 67 (SW1) has not been turned on at step S5, the control means 100 waits until it is turned on. When the paper detector 67 (SW1) has turned on, the control means 100 so judges that the leading edge of the paper has reached the paper detector 67 (SW1), and proceeds to step S6 to de-energize the electromagnetic clutch 66 (CLT1) that disconnects or connects the transmission of power to the pair of resist rotors 65, so that the pair of resist rotors 65 are maintained in a halted state, the electric motor 44 (M1) is driven and the timer 104 (T) is set to a predetermined set time T1. The predetermined set time T1 is a time required until the leading edge of the paper that has passed over the paper detector 67 (SW1) comes into contact with the nipping portion of the pair of resist rollers 65 that are in a halted state, and has been set to be, for example, 150 μsec. Even after the leading edge has come in contact with the nipping portion of the pair of resist rollers 65, the paper P is still being sent by the pair of discharge rollers 35 of the copier body 2. Therefore, the paper P is guided by the end on the upstream side of the upper guide plate 61 constituting the paper guide means 60 and by the guide plate 411 provided in the paper introduction port, and becomes curved to form a so-called loop as indicated by a dot-chain line in FIG. 1.

Next, the control means 100 proceeds to step S7 and checks whether the elapsed time TS has reached the above set time T1 after the paper detector 67 (SW1) had been turned on. When the elapsed time TS does not still reach the set time T1, the control means 100 waits until it reaches the set time T1. When the elapsed time TS has reached the set time T1, the control means 100 so judges that the leading edge of the paper has come in contact with the nipping portion of the pair of resist rollers 65 and, then, proceeds to step S8 to energize the flapper-type solenoid 84 (SOL3). When the flapper-type solenoid 84 (SOL3) is energized, the flapper 843 is attracted to be pulled downward from the state of FIG. 9(a), and the engaging portion 843b is brought to a position in a gap between the anchoring portion 834c of the anchoring pawl 834b and the outer peripheral surface of the main body 834a. Therefore, the rotary control member 834 is allowed to rotate, and the driving force transmitted to the drive gear 78 is transmitted to the cam shaft 76 via the spring clutch 83. Therefore, the rotation control member 834, too, rotates in a direction indicated by an arrow as shown in FIG. 9(b). Further, as the control means 100 energizes the flapper-type solenoid 84 (SOL3) at step S8, simultaneously it sets the timer 104 (T) to a predetermined set time T2. The predetermined set time T2 is a time required until the rotation control member 834 is turned by about 90 degrees from the state of FIG. 9(a) to the state of FIG. 9(b) after the flapper-type solenoid 84 (SOL3) had been energized, and has been set to be, for example, 25 μsec. When the rotation control member 834 is allowed to turn, the driving force transmitted to the drive gear 78 is transmitted to the cam shaft 77 through the spring clutch 83 as described above. Accordingly, the cam shaft 76 is rotated in the direction indicated by an arrow from a state of FIG. 10(a) to a state of FIG. 10(b).

Next, the control means 100 proceeds to step S9 to energize the flapper-type solenoid 84 (SOL3) and to check whether the elapsed time TS has reached the above set time T2 after the rotation control member 834 had started rotating. When the elapsed time TS does not reach the set time T2, the control means 100 waits until it reaches the set time T2. When the elapsed time TS has reached the set time T″, the control means 100 so judges that the rotation control member 834 has turned by about 90 degrees from a state of FIG. 9(a) to a state of FIG. 9(b), and proceeds to step S10 to de-energize the flapper-type solenoid 84 (SOL3). The control means 100 further sets a timer 104(T) to a predetermined set time T3. The predetermined set time T3 is a time required until the rotation control member 834 rotates by about 270 degrees from the state of FIG. 9(b) to reach a position of FIG. 9(c), and has been set to be, for example, 75 μsec. The cam 77 mounted on the cam shaft 76, too, rotates in the direction indicated by an arrow from the state shown in FIG. 10(b). The punch 72 reaches the lowest punching position in a state where the cam 77 has turned by about 180 degrees from the state of FIG. 10(b) to the state of FIG. 10(c). In this state, the punch 72 operated by the pushing mechanism 73 has its punching blade 721 at the lower end thereof moved down to a position under the lower guide plate 62 passing through the hole 611 formed in the upper guide plate 61 and through the punching hole 621 formed in the lower guide plate 62. During this period, two holes or three holes are punched in the paper P that has been conveyed between the upper guide plate 61 and the lower guide plate 62. As the cam shaft 76 or the cam 77 further rotates in the direction of the arrow from the state of FIG. 10(c), the punch 72 operated by the pushing mechanism 73 rises to a position above the upper guide plate 61. Then, as the cam shaft 76 rotates by 270 degrees from the state of FIGS. 9(b) and 10(b) (rotates one turn from the state of FIGS. 9(a) and 10(a)), the anchoring portion 834c of the anchoring pawl 834b of the rotation control member 834 comes in contact with the engaging portion 843b of the flapper 843 of the flapper-type solenoid 84 (SOL3) as shown in FIG. 9(a) to limit the rotation of the rotation control member 834. Therefore, the transmission of drive power by the spring clutch 83 is interrupted and the cam shaft 76 ceases to rotate. In this state, the cam 77 mounted on the cam shaft 76 and the pushing mechanism 73 return to the state (retracted position) shown in FIG. 10(a).

At the time of returning back to the retracted position shown in FIG. 10(a) from the state of being punched by the punch 72 shown in FIG. 10(c), it becomes difficult to move the punch 72 toward the retracted position when the resisting force between the punch 72 and the paper having been punched is larger than the resilient force of the compression coil spring 79. In the illustrated embodiment, however, the cam 77 that rotates acts on the lower surface of the return-operation portion 733c of the return member 733 to push up the pushing mechanism 73. Therefore, the punch 72 coupled to the pushing mechanism 73 can be brought to the predetermined retracted position.

In the state shown in FIG. 10(c), when the cam 77 has not been brought to the positions to correspond to the pushing member 730, the punch does not operate. If the punch 72 has moved down due to some cause, however, either the sub-return operation portion 733f or 733g is constituted to correspond to the cam 77. Therefore, the cam 77 acts on the lower surface of the sub-return operation portion 733f (733g) to push the pushing mechanism 73 up thereby to bring the punch 72 to the predetermined retracted position.

When the flapper-type solenoid 84 (SOL3) is de-energized at step S10 and the timer 104 (T) is set to the predetermined set time T3, the control means 100 proceeds to step S11 to check whether the elapsed time TS has reached the above set time T3 after the flapper-type solenoid 84 (SOL3) had been de-energized. When the elapsed time TS does not reach the set time T3, the control means 100 waits until it reaches set time. When the elapsed time TS has reached the set time T3, the control means 100 so judges that the punching operation has finished and proceeds to step S12 to energize the electromagnetic clutch 66 (CLT1). When the electromagnetic clutch 66 (CLT1) is energized, the pair of resist rollers 65 are driven to convey the paper subjected to the two-hole punching or to the three-hole punching toward the pair of discharge rollers 42, and then the paper is discharged by the pair of discharge rollers 42 onto a tray 48 for non-sorting. The control means 100 sets the timer 104 (T) to a predetermined set time T4. The predetermined set time T4 is a time required for judging whether the punching operation has ended for the last paper on which the image has been formed in the copier body 2 and which has been conveyed to the after-treatment device 4.

Next, the control means proceeds to step S13 to check whether the elapsed time TS has reached the set time T4 after the paper punched had been conveyed toward the pair of discharge rollers 43 by driving the pair of resist rollers 65. When the elapsed time TS does not reach the set time T4, the control means 100 proceeds to step S14 to check whether the paper detector 67 (SW1) has been turned on. When the paper detector 67 (SW1) has been turned on, it is so judged that the leading end of the next paper has reached the paper detector 67 (SW1), and the routine returns to step S6 to repeat the procedures of step S6 through step S14. When the paper detector 67 (SW1) has not been turned on at step S14, the next paper is not conveyed from the copier body 2. Therefore, the routine returns back to step 13, and the procedures of step S13 and step S14 are repeated. When the elapsed time TS has reached the set time T4 after the paper punched had been conveyed toward the pair of discharge rollers 42 by driving the pair of resist rollers 65 while repeating the procedures of step S13 and step 14, the control means 100 so judges that the punching operation has ended for the last paper on which the image has been formed in the copier body 2 and which has been conveyed to the after-treatment device 4. The control means 100, then, proceeds to step S15 and de-energizes the electromagnetic solenoid 750 (SOL2) that operates the change-over shaft 74, de-energizes the electromagnetic clutch 66 (CLT1) and brings the electric motor 44 (M1) into a halt to end the punching operation.

In the foregoing has been described the invention by way of a illustrated embodiment. The invention, however, is in no way limited to the illustrated embodiment only. In the illustrated embodiment, the invention is applied to the after-treatment device. According to the present invention, however, the paper punching device may be incorporated in the image-forming apparatus.

Being constituted as described above, the paper punching device according to the invention exhibits actions and effects as described below.

That is, according to the present invention, the punch-operating mechanism includes a cam shaft disposed along a direction in which said plural pushing mechanisms are arranged, plural cams formed on said cam shaft, a cam drive mechanism for rotating said cam shaft, and a cam position change-over mechanism which operates said cam shaft in the axial direction so as to be selectively brought to a first position where some cams out of the plural cams correspond to some pushing members out of said plural pushing members and to a second position where the other cams out of said plural cams correspond to the other pushing members out of said plural pushing members. Upon moving the cam shaft in the axial direction, it is allowed to select two kinds of holes. Therefore, the device can be constituted in a compact size using a decreased number of parts. As a result of decrease in the number of parts that operate, the obtained paper punching device produces small noise.

What we claim is:

1. A paper punching device disposed on a paper conveyer passage for punching plural holes in a paper that passes on said paper conveyer passage, comprising:
plural punches disposed on the upper side of said paper conveyer passage at right angles with the direction in which the paper is conveyed;
plural pushing members mounted on the upper ends of said plural punches; and
a punch-operating mechanism for operating said plural pushing mechanisms;
wherein said punch-operating mechanism includes a cam shaft disposed along a direction in which said plural pushing mechanisms are arranged, plural cams mounted on said cam shaft, a cam drive mechanism for rotatively driving said cam shaft, and a cam position change-over mechanism which operates said cam shaft in the axial direction so as to be selectively brought to a first position where some cams out of the plural cams correspond to some pushing members out of said plural pushing members and to a second position where the other cams out of said plural cams correspond to the other pushing members out of said plural pushing members.

2. A paper punching device according to claim 1, wherein each of said pushing members is provided with a return member having a pair of support portions mounted on both ends thereof and extending upward and a return operation portion coupling the upper ends of said pair of support portions together, and the cam acts on the lower surface of said return member.

3. A paper punching device according to claim 2, wherein the return operation portion of said return member is provided with sub-return operation portions corresponding to said cam in a state where said cam has not been brought to the position corresponding to the pushing member.
